(19) United States
(12) Patent Application Publication
(10) Pub. No.: US 2026/0037342 A1
(43) Pub. Date: Feb. 5, 2026

(54) SYSTEMS AND METHODS FOR GENERATING AN INTERACTIVE USER INTERFACE USING ARTIFICIAL INTELLIGENCE

(71) Applicant: STATS LLC, Chicago, IL (US)

(72) Inventors: Alyssa CHOI, Forest Hills, NY (US); Ysabel GONZALEZ-RICO, Atlanta, GA (US); Robert SEIDL, Munich (DE); Patrick Joseph LUCEY, Chicago, IL (US)

(73) Assignee: STATS LLC, Chicago, IL (US)

(21) Appl. No.: 19/280,329

(22) Filed: Jul. 25, 2025

Related U.S. Application Data
(60) Provisional application No. 63/678,853, filed on Aug. 2, 2024.

(51) Int. Cl. G06F 9/54; G06F 9/451

(52) U.S. Cl. CPC G06F 9/542; G06F 9/451

(57) ABSTRACT

According to systems and techniques disclosed herein, a method for generating an interactive user interface using artificial intelligence models may include receiving one or more streams of event data (e.g., real-time or non-live event data) comprising a plurality of visual elements (e.g., real-time or non-live visual elements). The method may further include providing the plurality of visual elements to a computer vision artificial intelligence model trained to classify the plurality of visual elements and output object identifiers and a confidence score associated with each of the object identifiers. The method may further include receiving user input from the interactive user interface displayed on a user device. The user input may include a user query associated with a first object identifier of the object identifiers. The method may further include updating the interactive user interface with one or more interactive user elements associated with the first object identifier.

### TECHNICAL FIELD

Various embodiments of this disclosure relate generally to computer-implemented techniques for generating an interactive user interface using artificial intelligence, and, more particularly, to systems and methods for generating an interactive user interface for user queries based on real-time event elements.

### BACKGROUND

With the advent of generative artificial intelligence (AI), more people may rely on AI models (e.g., AI assistants) to answer questions or provide responses on a topic. Current AI models may lack specific knowledge or training on sports-related fields of inquiry.

Unless otherwise indicated herein, the materials described in this section are not prior art to the claims in this application and are not admitted to be prior art, or suggestions of the prior art, by inclusion in this section.

### SUMMARY OF THE DISCLOSURE

In one aspect, an exemplary embodiment of a method for generating an interactive user interface using artificial intelligence models of a computing system may include receiving one or more streams of event data comprising a plurality of visual elements. The method may further include providing the plurality of visual elements to a computer vision artificial intelligence model trained to classify the plurality of visual elements and output one or more object identifiers and a confidence score associated with each of the one or more object identifiers. The method may further include receiving user input from the interactive user interface displayed on a user device. The user input may include a user query associated with a first object identifier of the one or more object identifiers. The method may further include updating the interactive user interface with one or more interactive user elements associated with the first object identifier.

In another aspect, an exemplary embodiment of a system for generating an interactive user interface using artificial intelligence models may include a memory storing instructions and one or more processors operatively connected to the memory and configured to execute the instructions to perform operations. The operations may include receiving one or more streams of event data comprising a plurality of visual elements. The operations may further include providing the plurality of visual elements to a computer vision artificial intelligence model trained to classify the plurality of visual elements and output one or more object identifiers and a confidence score associated with each of the one or more object identifiers. The operations may further include receiving user input from the interactive user interface displayed on a user device. The user input may include a user query associated with a first object identifier of the one or more object identifiers. The operations may further include updating the interactive user interface with one or more interactive user elements associated with the first object identifier.

In a further aspect, an exemplary embodiment of a non-transitory computer-readable medium storing instructions that, when executed by one or more processors, perform operations. The operations may include receiving one or more streams of event data comprising a plurality of visual elements. The operations may further include providing the plurality of visual elements to a computer vision artificial intelligence model trained to classify the plurality of visual elements and output one or more object identifiers and a confidence score associated with each of the one or more object identifiers. The operations may further include receiving user input from the interactive user interface displayed on a user device. The user input may include a user query associated with a first object identifier of the one or more object identifiers. The operations may further include updating the interactive user interface with one or more interactive user elements associated with the first object identifier.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 depicts an exemplary environment for generating an interactive user interface, according to one or more embodiments.

FIG. 2 depicts an exemplary data flow diagram for generating an interactive user interface, according to one or more embodiments.

FIGS. 3A-3C depict exemplary data stores including historical event data, according to one or more embodiments.

FIGS. 4A-4C depict exemplary interactive user interfaces, according to one or more embodiments.

FIG. 5 depicts an exemplary interactive user interface including a user input and a generated sequence of outputs, according to one or more embodiments.

FIG. 6 depicts a flowchart of an exemplary method for generating an interactive user interface using artificial intelligence models, according to one or more embodiments.

FIG. 7 depicts a flowchart of an exemplary method for generating an interactive user interface, according to one or more embodiments.

FIG. 8 depicts a flow diagram for training a machine-learning model, according to one or more embodiments.

FIG. 9 depicts an example of a computing device, according to one or more embodiments.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION OF ASPECTS

Various aspects of the present disclosure relate generally to computer-implemented techniques for generating an interactive user interface for user queries based on real-time event elements.

In an exemplary use case, a user may interact with a real-time sporting event by inputting queries into an interactive user interface. The user input, along with real-time event data may be provided to an artificial intelligence (AI) model to generate a sequence of outputs. In such an example, a user may query a generative AI model about a tennis racket being used by a player in a broadcast tennis match. Using the real-time event data, the AI model may respond to the user query with a sequence of outputs contextually relevant to the query. The generative AI model may also generate and output shopping links or other promotional outputs related to the tennis racket.

In another exemplary use case, a user may interact with a non-live sporting event (e.g., previously broadcasted, recorded, or a replay) by inputting queries into an interactive user interface. The non-live sporting event may be displayed as a replay, highlights, or the like. The interactive user interface may be overlaid on a social media reel, video, stream, or the like. The user input, along with event data, may be provided to an AI model to generate a sequence of outputs. In such an example, a user may query the generative AI model about an article of clothing being worn by a player in a non-live tennis match. Using the event data, the AI model may respond to the user query with a sequence of outputs contextually relevant to the query. The generative AI model may also generate and output shopping links or other promotional outputs related to the article of clothing.

In such examples, a user may be able to interact with a language learning model (LLM) that is trained to output responses to user questions or user interactions, using the real-time, or non-live, event data, historical event data, and/or user input. In this way, a user may interact with real-time, or non-live, game event data and live output (e.g., the generated interactive user interface).

Therefore, the present disclosure also provides for machine-learning and artificial intelligence models. Using artificial-intelligence based techniques for natural language processing may allow for user interaction with the data. Techniques disclosed herein further reduce the computational resources required for such processing by, for example, leveraging machine learning training to reduce just-in-time processing loads.

As used herein, a “machine-learning model” and/or “artificial intelligence (AI) model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

As discussed herein, one or more AI models may be trained to understand a sports language. Accordingly, AI models disclosed herein are sports machine learning models. Such sports AI models may be trained using sports related data (e.g., tracking data, event data, etc., as discussed herein). A sports AI model trained to understand a sports language based on sports related data may be trained to adjust one or more weights, layers, nodes, biases, and/or synapses based on the sports related data. A sports AI model may include components (e.g., weights, layers, nodes, biases, and/or synapses) that collectively associate one or more of: a player with a team or league; a team with a player or league; an article of clothing with a player or team; an accessory with a player or team; a sports apparatus with a player or team; and/or the like.

A sports AI model may be trained based on sports tracking and/or event data, as discussed herein. Such data may include player and/or object position information, movement information, trends, and/or changes. For example, a sports AI model may be trained by modifying one or more weights, layers, nodes, biases, and/or synapses to associate given positions in reference to the playing surface of venue and/or in reference to one or more agents. As another example, a sports AI model may be trained by modifying one or more weights, layers, nodes, biases, and/or synapses to associate given movement or trends in reference to the playing surface of venue and/or in reference to none or more agents. As another example, a sports AI model may be trained by modifying one or more weights, layers, nodes, biases, and/or synapses to associate sporting events with corresponding time boundaries, teams, players, coaches, officials, and environmental data associated with a location of corresponding sporting events.

The execution of the AI model may include deployment of one or more machine-learning techniques, such as a transformer model, graph neural network (GNN), linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine-learning and artificial intelligence, it should be understood that techniques according to this disclosure may be adapted to any suitable type of machine-learning and/or artificial intelligence. It should also be understood that the examples above are illustrative only. The techniques and technologies of this disclosure may be adapted to any suitable activity.

While several examples described herein relate to the use of real-time event data (e.g., event data captured or obtained within approximately under 5 minutes, 3 minutes, 1 minute, 30 seconds, or 10 seconds of a corresponding physical event), it should be understood that any type of event data may be used with the techniques and systems described herein. Therefore, event data, as described herein, may relate to real-time event data as captured from a live feed, broadcast, or the like. Additionally, event data may also relate to non-live event data captured, stored, or retrieved from one or more previous feeds or broadcasts. The non-live event data may also be captured from a live broadcast that includes a previously broadcasted event or from a replay of the event).

While sporting events and various aspects relating to sporting events (e.g., game events during a sporting event) are described in the present aspects as illustrative examples, the present aspects are not limited to such examples. For example, the present aspects can be implemented for other types of events or actions, such as, for example, financial activities, consumer activities, AI assistants, or other implementations where an AI model is queried for a response.

While sporting event and various aspects relating to sporting events may be described in relation to a given sport, it will be understood that such aspects may be implemented for any applicable sport such as, but not limited to, team sports, individual sports, soccer, basketball, American football, rugby, golf, tennis, hockey, cricket and/or the like.

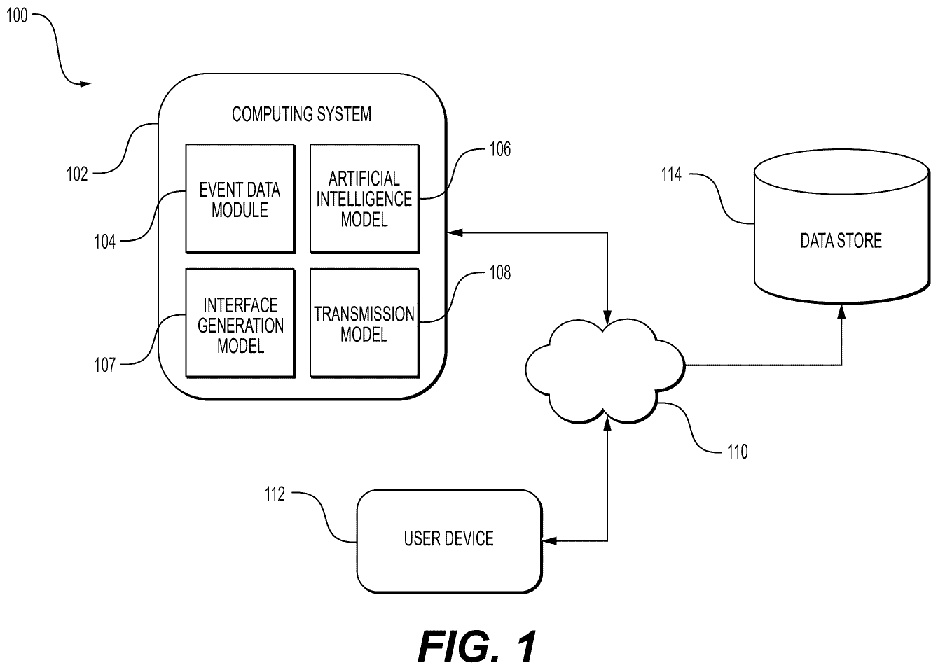

FIG. 1 depicts an exemplary environment 100 that may be utilized with techniques presented herein. One or more user device(s) 112 may communicate across an electronic network 110. The one or more user device(s) 112 may be associated with a user, e.g., a user that is viewing and/or interacting with a generated interactive user interface, an administrator of one or more components of environment 100, and/or the like. As will be discussed in further detail below, one or more computing system(s) 102 may communicate with one or more of the other components of the environment 100 across electronic network 110.

The user device(s) 112 may be configured to enable a user to access and/or interact with other systems in the environment 100. For example, the user device(s) 112 may each be a computer system such as, for example, a desktop computer, a mobile device, a tablet, an augmented/virtual/extended reality device, and etc. In some embodiments, the user device(s) 112 may include one or more electronic application(s), e.g., a program, plugin, browser extension, etc., installed on a memory of the user device(s) 112. In some embodiments, the electronic application(s) may be associated with one or more of the other components in the environment 100. For example, the electronic application(s) may include one or more of system control software, system monitoring software, software development tools, etc.

In various embodiments, the environment 100 may include a data store 114 (e.g., database). The data store 114 may include a server system and/or a data storage system such as computer-readable memory such as a hard drive, flash drive, disk, etc. In some embodiments, the data store 114 includes and/or interacts with an application programming interface for exchanging data to other systems, e.g., one or more of the other components of the environment. The data store 114 may include and/or act as a repository or source for storing real-time event data, non-live event data, historical event data, data related to user interactions, output data, and the like (e.g., to be transmitted to user device 112 or any of the other components of environment 100).

In some embodiments, the components of the environment 100 are associated with a common entity, e.g., a service provider, an account provider, or the like. For example, in some embodiments, computing system 102 and data store 114 may be associated with a common entity. In some embodiments, one or more of the components of the environment is associated with a different entity than another. For example, computing system 102 may be associated with a first entity (e.g., a service provider) while data store 114 may be associated with a second entity (e.g., a storage entity providing storage services to the first entity). The systems and devices of the environment 100 may communicate in any arrangement. As will be discussed herein, systems and/or devices of the environment 100 may communicate in order to one or more of generate, train, or use a machine-learning or an AI model to process natural language data, among other activities.

As discussed in further detail below, the computing system(s) 102 may, one or more of, (i) generate, store, train, communicate with, or use a machine-learning and/or AI model configured to process natural language data. The computing system(s) 102 may include a machine-learning model and/or instructions associated with the machine-learning model, e.g., instructions for generating a machine-learning model, training the machine-learning model, using the machine-learning model etc. The computing system(s) 102 may include instructions for retrieving data, adjusting data, e.g., based on the output of the machine-learning model, and/or operating a display of the user device(s) 112 to output generated responses to user input, e.g., as adjusted based on the machine-learning model. The computing system(s) 102 may include training data, e.g., language data, and may include ground truth, e.g., (i) training language data and (ii) training event data to generate natural language responses.

As depicted in FIG. 1, computing system(s) 102 may include event data module 104. In various embodiments, event data module 104 is configured to receive a plurality of real-time event data and a plurality of historical event data. The data may be gathered and/or compiled by the computing system 102 or using components separate from environment 100. The plurality of real-time event data may include a plurality of real-time athlete elements associated with a game identifier. The plurality of historical event data may include a plurality of historical athlete elements associated with an athlete identifier. In examples, the data may be associated with one or more players, a team, or the like during a match/game that may be identified (e.g., an accessory, sporting apparatus, equipment, or the like). In various implementations, the event data may be received by the event data module 104 almost simultaneous to an event action occurring or, at least, substantially simultaneous to an event action taking place. The plurality of real-time event data may be received by computing system(s) 102 over network 110. In examples, the real-time event data and/or the historical event data that documents the apparel and/or equipment of a player may be collected manually. In other examples, the data may be collected as a new game (e.g., broadcast) is occurring live, such as by using a computer vision system to identify the apparel/equipment and add that to a database (e.g., data store 114). In other examples, the data may be collected from a previous feed, stream, broadcast, or the like. Web links to relevant stores, websites, sponsors, and the like, may also be associated with the data in the database.

According to certain embodiments, event data module 104 may receive in-venue or broadcast data associated with a sporting event. Such in-venue or broadcast data may be used to generate the event data discussed herein. For example, such in-venue or broadcast data may be provided to one or more event machine-learning models. The one or more event machine-learning models may be trained based on training data that includes historical or simulated in-venue or broadcast data, historical or simulated event data (e.g., tagged data), historical or simulated event actions (e.g., tagged data), and/or the like. The training data may be used to train the event machine-learning models by modifying one or more weighs, layers, synapses, biases, and/or the like of the event machine-learning models, in accordance with a machine-learning algorithm, as discussed herein. Alternatively, or in addition, such in- venue or broadcast data may supplement received event data for verification and/or use to generate an event sequence. Event data module 104 may also receive historical event data, such as from data store 114, or the like. The historical event data may include historical athlete elements. In examples, such historical athlete elements may include items of clothing, sporting apparatuses, accessories, or the like.

Computing system(s) 102 may also include artificial intelligence module 106. In various embodiments, artificial intelligence module 106 may be configured to identify associations between the plurality of real-time athlete elements and the plurality of historical athlete elements and to generate an output including one or more interactive elements based on the identified associations. The output may be generated in real-time as the plurality of real-time event data is received. In this way, the output may be updated to reflect real-time events.

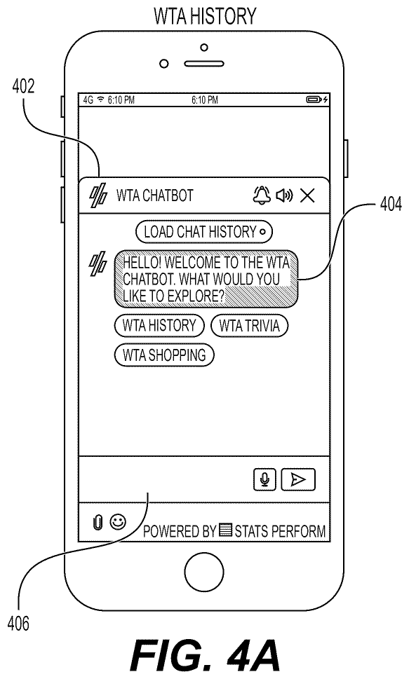

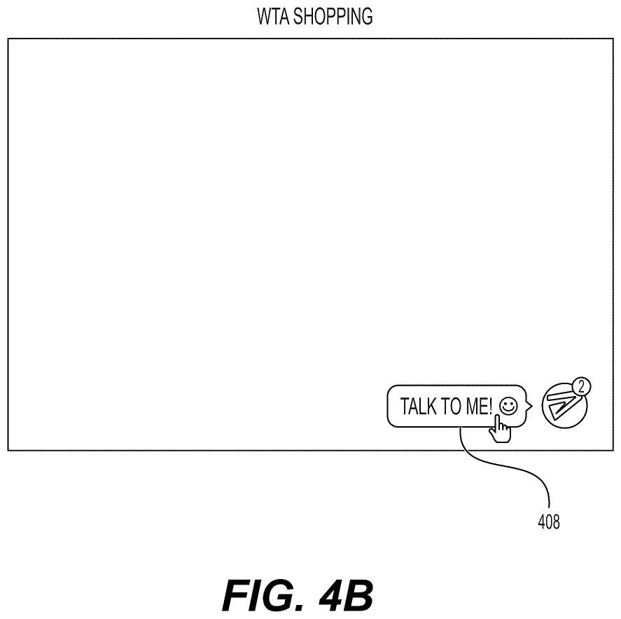

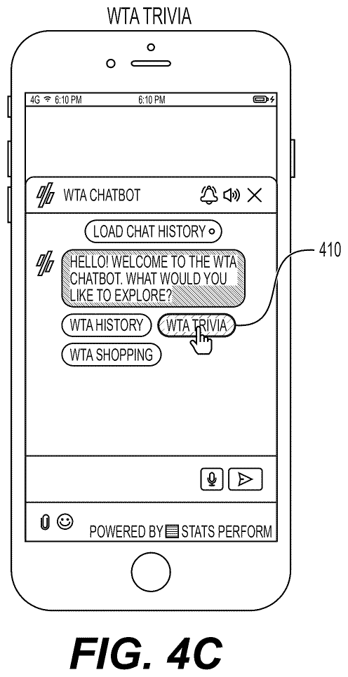

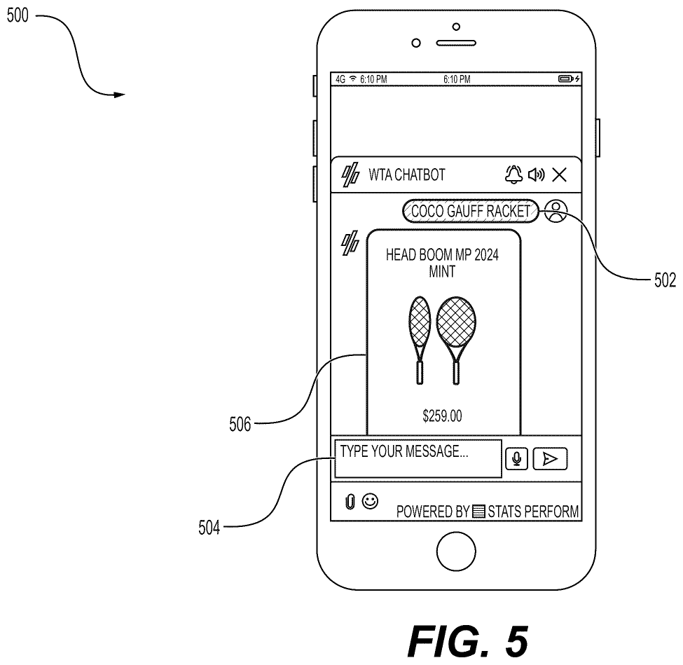

As depicted in FIG. 1, computing system(s) 102 may also include interface generation module 107. In various embodiments, interface generation module 107 may be configured to generate an interactive user interface. The interactive user interface may include one of one or more interactive elements, including one or more real-time event elements, generated sequences of responses, web links, promotional offers, or the like. The interactive user interface may be formatted in real time as the plurality of real-time event data is received. Exemplary embodiments of the interactive user interface will be described below in more detail with respect to FIGS. 4A-5. In various embodiments, the interactive user interface is generated in real-time as the plurality of real-time event data is received (e.g., by event data module 104). Computing system(s) 102 may also include transmission module 108. In various embodiments, transmission module 108 may be configured to transmit to a user interface (e.g., user device 112) the interactive user interface. In various embodiments, the interactive user interface and/or other items discussed herein may be displayed in real-time via applications (e.g., sports media applications, software applications, browser extensions, mobile applications, smart television applications, and the like), widgets (e.g., sports information cards, sports media stories, interactive elements within a software application, and the like), various graphics, and/or the like. In various embodiments, a database of event elements, athlete elements, and/or event data may be generated using the AI models as described herein. Further, based on a user input into the interactive user interface, an AI model may identify a broadcast or broadcasts (e/g. historic) associated with the user input, event elements, athlete elements, and/or event data and may identify a clothing item, apparatus, equipment, or the like as an output.

As depicted in FIG. 1, environment 100 may also include electronic network 110. In various embodiments, the electronic network 110 may be a wide area network (“WAN”), a local area network (“LAN”), personal area network (“PAN”), or the like. In some embodiments, electronic network 110 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

Although depicted as separate components in FIG. 1, it should be understood that a component or portion of a component in the environment 100 may, in some embodiments, be integrated with or incorporated into one or more other components. In another example, the computing system 102 may be integrated in a data storage system. The data storage system may be configured to communicate and/or receive/send data across electronic network 110 to other components of environment 100. In some embodiments, operations or aspects of one or more of the components discussed above may be distributed amongst one or more other components. Any suitable arrangement and/or integration of the various systems and devices of the environment 100 may be used.

Further aspects of the computing system 102 and how an interactive user interface is generated are discussed in further detail in the methods below. In the following methods and systems, various acts may be described as performed or executed by a component from FIG. 1, such as the computing system 102, the user device 112, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

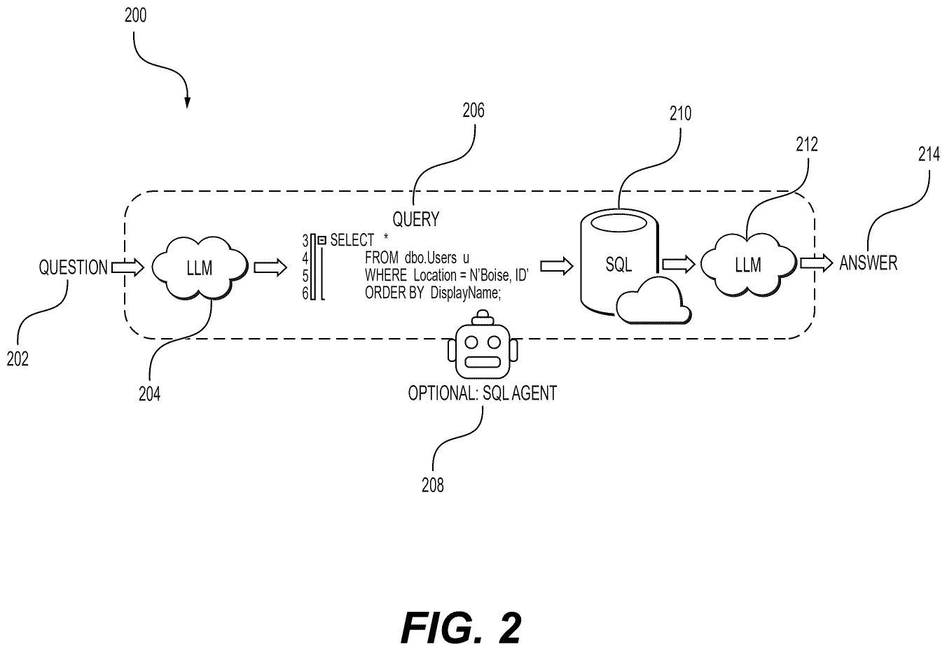

FIG. 2 depicts an exemplary data flow diagram 200 for generating an interactive user interface. As illustrated, a user may input a query (e.g., a question) into an AI model 204 (e.g., an LLM AI model). In examples, the input may include such phrases as “Tell me about that,” or “Where can I buy that?” or the like. The disclosed system may then access or receive real-time event data and historical event data from at least a data store 210 by querying 206 the data store 210. In examples, an SQL agent 208 may be utilized to query the data store 210. Data store 210 may store a plurality of real-time athlete elements associated with a game identifier and a plurality of historical athlete elements associated with an athlete identifier. The AI model may then identify associations between the plurality of real-time athlete elements and the plurality of historical athlete elements and to generate an output 214 (e.g., an answer) including one or more interactive elements based on the identified associations.

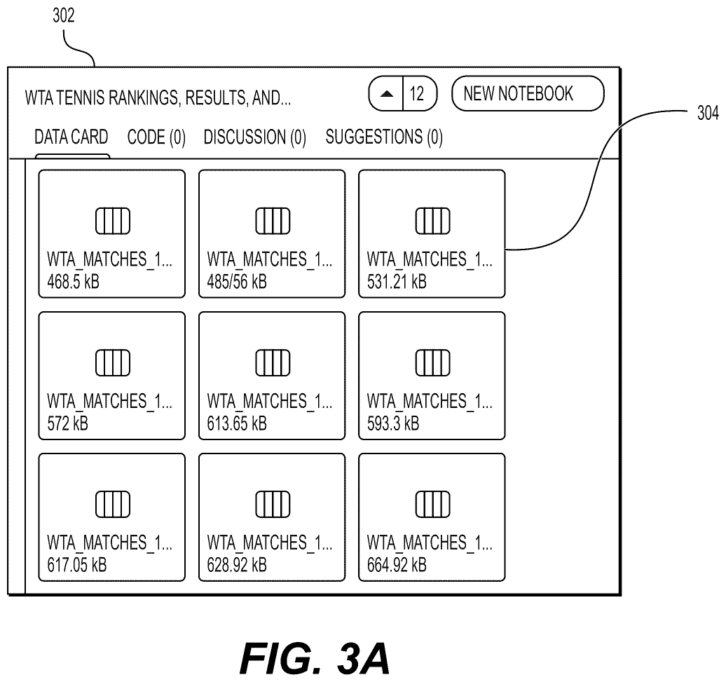

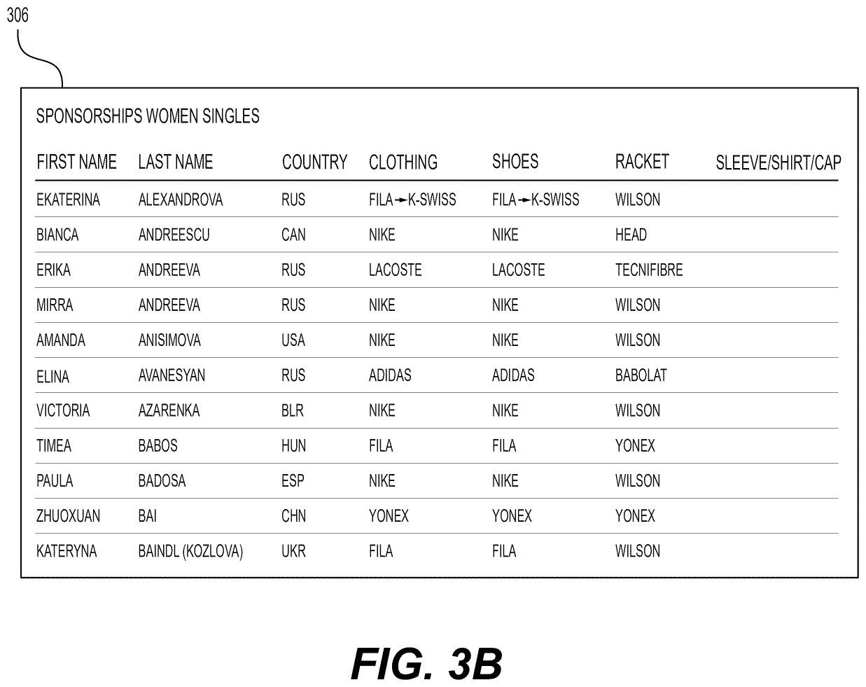

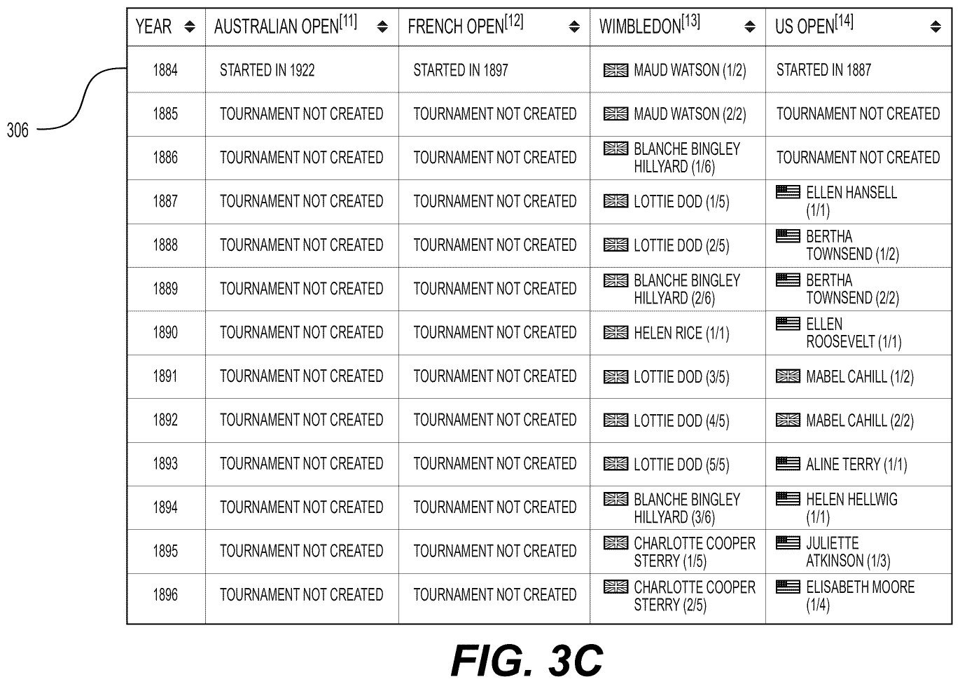

As depicted in FIGS. 3A-3C, data stores including historical event data may be accessed. Such data stores may include Kaggle™, Scoreandchange™, and Wikipedia™ data stores, or the like. For example, as depicted in FIG. 3A, a datastore of data cards may be displayed in a graphical user interface 302. A data card 304 may include a plain text file including data in a tabular format. In examples, the data card 304 may include data pertaining to Women's Tennis Association (WTA) matches associated with a certain year. Such data may include player names, matches played, resulting scores, player rankings, player tracking data, as described herein, and the like. As depicted in FIG. 3B, a data table 306 may also be accessed in the datastore. The data table 306 may include player names, player countries, and data related to articles used or worn by each player, such as clothing and/or shoe brand, racket brand or equipment brand or type used, or the like. As depicted in FIG. 3C, a database 308 may also be accessed in the datastore. The database 308 may include data related to games and matches (e.g., tennis), and historical data related to the games and/or matches, such as date of occurrence, players that participated in the match, and the like.

As described above, the AI model may identify associations between the plurality of real-time athlete elements and the plurality of historical athlete elements (e.g., such as those accessed in a datastore, as described with respect to FIGS. 3A-3C) and to generate an output including one or more interactive elements based on the identified associations. In an example, a user may see a tennis racket being used by an athlete in a real-time broadcast tennis match. The user may input the question “Where can I buy that?” into an AI model via a user interface. The AI model may then identify associations between the real-time broadcast data and historical data about the athlete and generate a response relevant to the user's question about the tennis racket. The response may include an interactive element in an interactive user interface, such as a web link to purchase the racket, or the like.

FIGS. 4A-4C depict exemplary interactive user interfaces. An interactive user interface 402 may include an invitation 404 to interact. A user input field 406 may be provided wherein a user may input one or more questions, statements (e.g., statement 408), or the like, to engage with the AI model supporting the interactive user interface 402. Additionally, the AI model and generated interactive user interface may provide quick links 410 to provide a user with prompts allowing interaction with the AI system.

FIG. 5 depicts an exemplary interactive user interface 500 including a user input 502 and a generated sequence of outputs 506. As described above, a user may input a question or statement into a user input field 504 of the interactive user interface 500. In the depicted example, a user may see a tennis racket being used by an athlete in a real-time broadcast tennis match. The user may input (e.g., via user input field 504) the statement “Coco Gauff Racket” into an AI model via a user interface to query the AI system about the racket. The AI model may then identify associations between the real-time broadcast data and historical data about the athlete and racket and generate a response 506 (e.g., sequence of outputs) relevant to the user's question via user input 502 about the tennis racket. The response may include an interactive element in an interactive user interface, such as a web link to purchase the racket, or the like, as illustrated.

As illustrated in FIG. 5, an exemplary graphical user interface incorporates the interactive user interface 500. As described above, the interactive user interface 500 may be generated by an interface generation module, such as that described with respect to FIG. 1 above. Interactive user interface 500 may be dynamically generated and updated in real time based on event data associated with a sporting event. The response 506 may include one or more interactive elements that may be configured to cause the interactive user interface 500 to update in response to one or more user interactions (e.g., a mouse click, haptic input, or the like). Such an update may include opening the provided web link and displaying the associated webpage in the interactive user interface.

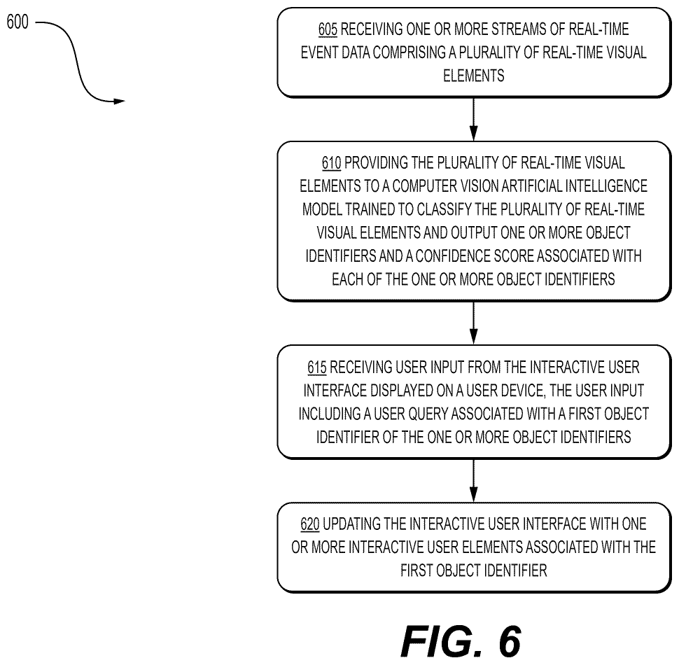

FIG. 6 illustrates a flowchart of an exemplary method 600 for generating an interactive user interface using one or more artificial intelligence models. At step 605, one or more streams of real-time event data may be received. In some embodiments, a broadcast feed of a given sports match may include one or more streams of real-time event data. In examples, each frame of the broadcast feed may be extracted from the feed and stored in a game file. A broadcast feed may be a feed that is formatted to be broadcast over one or more channels (e.g., broadcast channels, internet-based channels, etc.). A game file may be converted from a first format (e.g., a format output by one or more cameras or a different format than the format output by the one or more cameras) and may be converted into a second format (e.g., for broadcast transmission). In embodiments, the real-time event data may be generated based on tracking data and/or content feeds (e.g., in-venue video feeds, broadcast feeds, etc.). For example, tracking data may be generated by providing a content feed to one or more machine learning models. The one or more machine learning models may identify players and/or objects in the content feed and convert them into digital representations. The real-time event data may therefore include a plurality of real-time visual elements. The real-time visual elements may be associated with a game identifier (e.g., associated with a game file).

At step 610, the plurality of real-time visual elements may be provided to one or more computer vision artificial intelligence models. Computer vision may interpret and analyze visual data (e.g., the real-time visual elements) using machine-learning techniques, as disclosed herein. In various embodiments, techniques of image matching, such as capturing images of individuals and/or objects and generating one or more correlation scores between the images and a database of images to find matches, may be used in aspects. Further, data extraction, such as identifying markings, words, and/or numbers on objects such as sports equipment or jerseys, and comparing such elements to a database to identify individuals and/or objects, may also be used. For these and other such processes, the visual data captured may be converted from a visual format to a second format that is used by a machine-learning model, as described herein.

For example, and in various embodiments, before an image may be analyzed by a machine-learning model (e.g., a deep learning model), the image, or images, may be converted (including preprocessing) into a numerical format that the machine-learning model is able to process. In examples, the second format may be a tensor (e.g., a multi-dimensional array of numbers) that is able to be processed by the machine-learning model. In various embodiments, the machine-learning model may not be able to process an image, or images, without first converting the image into the second format. In examples, machine-learning models may only operate on numerical data (e.g., may only be able to process data that has been converted into a numerical format). Images, in their raw form (e.g., JPEG, PNG), may include visual information that may need to be converted into numerical data in order for the machine-learning model to be able to perform calculations and learn from the data.

Images may have width, height, and color channels (e.g., Red, Green, Blue for RGB images). Tensors (e.g., multi-dimensional arrays), may therefore represent such a structure of an image as a multi-dimensional array of numerical data. For example, a color image may be represented as a 3-dimentional tensor with dimensions corresponding to height, width, and the three color channels.

Preprocessing steps that may be involved in converting images to tensors may include resizing, normalization, and augmentation. As images may come in varying sizes, and neural networks typically require inputs of a fixed size, resizing may ensures that all images have the same dimensions for consistent input into the machine-learning model. Further, pixel values in images may range from 0 to 255 (for 8-bit images). Therefore, normalizing these values to a smaller range (e.g., 0 to 1) may allow the machine-learning model to learn more effectively and may also improve stability in training the machine-learning model. Still further, applying random transformations (e.g., rotations, flips, or shifts) to the images, via augmentation, may increase the diversity of the training data for the machine-learning model and may make the machine-learning model more robust to adapt to variations in image appearance. Therefore, images may be converted (e.g., transformed) into tensors through various preprocessing steps as described above, thereby allowing the machine-learning model to process and learn from the visual information of the images. In various embodiments, the conversion of the image into the second format (e.g., into a tensor) may be performed automatically by the computing system, before providing the data (e.g., the image) to the machine- learning model.

Therefore, computer vision models, such as those disclosed herein, may detect, classify, and locate objects within visual data (e.g., the real-time visual elements) to extract features, track movements, and/or recognize text, and the like, as a broadcast is occurring (e.g., streaming or broadcasting) in real time. Deep learning, such as one or more convolutional neural networks (CNNs) may recognize patterns and features in visual data. A computer vision artificial intelligence model may therefore be trained to classify the plurality of real-time visual elements and output one or more object identifiers and a confidence score associated with each of the one or more object identifiers. In an example, the computer vision artificial intelligence model may classify visual data related to a tennis match and may classify or identify a racquet being used by a player in the tennis match, and/or the clothing being worn by the player, or the like. In this way, the computer vision artificial intelligence model may tag equipment, apparel, or any visual element of the real-time event data (e.g., broadcast feed) in real time. An object identifier may be associated with each of the classified objects (e.g., the racquet and each article of clothing, and the like). In examples, the object identifier may be a string of numeric and/or textual characters that is associated with a unique object and which uniquely identifies the object in the computing system. In various embodiments, a confidence score may be associated with each object identifier. For example, the computer vision artificial intelligence model may assign or associate a higher confidence score with an object depending upon a likelihood that the object identified or classified (e.g., a racquet) has been classified accurately (e.g., as a racquet). The confidence score may also be associated with a likelihood that the object has been accurately classified as being of a particular brand, type, or the like.

In various embodiments, a data structure may be generated that includes the object identifier (e.g., of the racquet) and the confidence score associated with that object identifier. The data structure may be stored in a database associated with the computing system (e.g., data store 114, as depicted in FIG. 1), and may be accessed by various components of the computing system, as described herein, for analysis of the data, processing of the data, outputting of the data, or the like.

At step 615, user input may be received from an interactive user interface displayed on a user device (e.g., such as interactive user interface 500, as depicted in FIG. 5). The user input may include a user query associated with a first object identifier (e.g., associated with the classified or identified racquet). In examples, such a user query may include a textual user input such as, “Where can I buy the racquet that the player is using in this match?” In examples, the user query may trigger the generation of an advertisement or recommendation by the system for display on the user device.

Therefore, the user input may be matched to the object identifier in order to generate the output for display on the user device. In various embodiments, the user input may be matched with an object identifier using the computer vision techniques described herein, and by accessing stored (e.g., historical) sports data. For example, the confidence score associated with the object identifier by the computer vision artificial intelligence model may be used in order to match the user input with an accurate object identifier. Therefore, a large language machine-learning model (LLM) may process the user input for context related to the user query, and the computer vision machine-learning model may then identify and output the object identifier that matches the user input. The output object identifier may then be provided back to the LLM which may then generate textual output to display on the user device, including one or more interactive elements.

At step 620, the interactive user interface may be updated with one or more interactive user elements associated with the first object identifier and the generated advertisement, recommendation, or the like. In various embodiments, the one or more interactive user elements may include a textual or image-based response to the user query, and displayed on the user device, such as “You can buy the racquet used by the player in this match online at Dick's Sporting Goods.” The one or more interactive user elements may also include one or more affiliate links to an online store to facilitate the purchase of the item (e.g., a link to the listing of the racquet for purchase on Dick's Sporting Good's website).

In various embodiments, a plurality of real-time metadata associated with a plurality of entities may also be received. In examples, the real-time metadata may include live market data associated with the entities (e.g., merchants), such as items that are for sale from various merchants in real time. The real-time metadata may be provided to the computer vision artificial intelligence model. The computer vision artificial intelligence model may be trained to identify associations between the real-time metadata and the one or more object identifiers and output one or more entities associated with the first object identifier. For example, the one or more entities may include various merchants that are selling the racquet. In embodiments, the one or more interactive user elements may be associated with the one or more entities, such as described above. Therefore, a number of possible associations between the real-time metadata and the object identifiers may be narrowed by one or more artificial intelligence models to a particular merchant or small group of merchants that are relevant to the user query, based on the context provided by the real-time metadata. In this way, a user may not need to search online resources to find the particular racquet used in the tennis match during the broadcast, and then determine where the user may purchase the racquet. Artificial intelligence models may therefore be leveraged to analyze input, determine a result, and output the result almost instantly and without user prompting. Further, the one or more entities may each be associated with a weighted score. In examples, each entity (e.g., merchant) may be able to pay an additional fee to be featured in the interactive user elements (e.g., listed first in the display provided to the user device, or the like).

In various embodiments, a second user query associated with the first object identifier may be received from the interactive user interface. In examples, such a user query may include a textual input such as, “I only have $100 to spend on the racquet”, “I need the racquet shipped overnight,” or “I would like to buy the racquet from a local store.” The second user query, the first object identifier, and the plurality of real-time metadata may be provided to one or more artificial intelligence models, such as a language artificial intelligence model. A language artificial intelligence model may be trained to identify patterns between the second user query, the first object identifier, and the plurality of real-time metadata and output one or more recommendations (e.g., for buying the racquet based on the context of the second user query). Therefore, a user may be able to have a conversation with the system about an object identified in the real-time event data. The interactive user interface may be updated with one or more second interactive user elements based on the one or more recommendations. In various embodiments, the one or more interactive user elements may include a textual or image-based response to the user query, such as “You can buy a similar racquet to the one used by the player in this match for $98 online at Dick's Sporting Goods,” “You can buy the racquet on Amazon with overnight delivery,” or “You can buy the racquet at Mike's Sporting Goods, which is 5 miles away.” The one or more interactive user elements may also include one or more affiliate links to an online store to facilitate the purchase of the item (e.g., a link to the similar racquet on the Dick's Sporting Goods website, the link to purchase the racquet on Amazon, or a link to a website for the local sporting goods store, or a link to turn-by-turn directions to the local sporting goods store that has the racquet in stock). In further examples, various merchants may participate in an auction whereby users may view various merchant offerings of a particular object (e.g., the racquet) simultaneously, thereby allowing the user to make a purchasing decision based on a grouping of real-time metadata. In examples, the auction may be implemented as an overlaid graphical user interface on a social media platform feed.

In various embodiments, the second user query may draw upon the contextual data resulting from the analysis of the real-time metadata by the language artificial intelligence model and/or other artificial intelligence models as described herein. For example, a user query may include “I would like to buy the shoes the player is wearing, but in a child size.” In such embodiments, the user query may be analyzed by one or more artificial intelligence models to determine context for matching to the most relevant market data of the real-time metadata. One or more interactive user elements may therefore be generated that may include one or more affiliate links to an online store to facilitate the purchase of the related item (e.g., a link to purchase the shoes in a child's size).

Accordingly to embodiments disclosed herein, a second user query may be a subset of a first user query or may be a subsequent user query. The second user query may include filter criteria. Filter criteria may be, for example, price based criteria, size based criteria, time based criteria (e.g., a duration of time such as for a given sporting even tor multiple sporting events), a flexibility criteria (e.g., words or numerical values used to generate a range such as a correlation range or matching range), merchant criteria, merchant type or category, and/or the like. According to embodiments, the second user query may be automatically extracted (e.g., instead of being provided by a user). For example, the second user query may be automatically extracted based on a user profile, user history (e.g., user purchase history), user preferences, market trends, cohort information (e.g., data related to other user's queries or purchases), etc.

Accordingly, the second user query (e.g., filter criteria) may limit the scope of the potential interactive user elements. Continuing the example above, the second query may be used to apply a filter to provide one or more interactive user elements that correspond to shoes in children sizes, thereby excluding interactive user elements that do not correspond to children sizes.

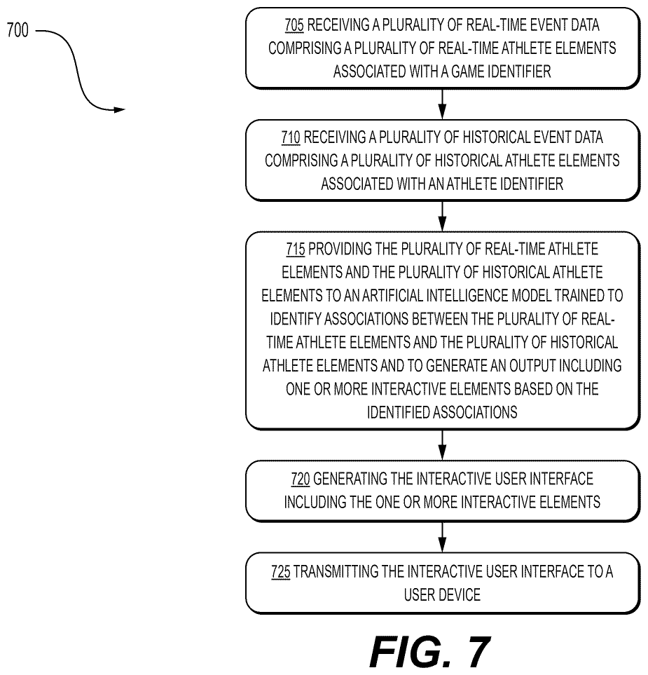

FIG. 7 illustrates a flowchart of an exemplary method 700 for generating an interactive user interface. At step 705, a plurality of real-time, or non-live, event data comprising a plurality of real-time athlete elements associated with a game identifier is received. At step 710, a plurality of historical event data comprising a plurality of historical athlete elements associated with an athlete identifier is received. In examples, such data may be stored and/or accessed in a data store (such as data store 114 as described with respect to FIG. 1).

The plurality of real-time event data and/or plurality of historical event data may be generated using tracking data (e.g., by event data module 104). For example, a tracking system may be positioned in a venue and/or may be in communication (e.g., electronic communication, wireless communication, wired communication, etc.) with components located at the venue. For example, the venue may be configured to host a sporting event that includes one or more agents. The tracking system may be configured to capture the motions of one or more agents (e.g., players) on the playing surface, as well as one or more other agents (e.g., objects) of relevance (e.g., ball, puck, referees, etc.). In some embodiments, the tracking system may be an optically-based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system may result in one or many different camera views of the playing surface (e.g., high sideline view, free-throw line view, huddle view, face-off view, end zone view, etc.).

In some embodiments, a tracking system may be used for a broadcast feed of a given match. For example, tracking system may be used to generate game files to facilitate a broadcast feed of a given match. In such embodiments, each frame of the broadcast feed may be stored in a game file. A broadcast feed may be a feed that is formatted to be broadcast over one or more channels (e.g., broadcast channels, internet based channels, etc.). A game file may be converted from a first format (e.g., a format output by the one or more cameras or a different format than the format output by the one or more cameras) and may be converted into a second format (e.g., for broadcast transmission).

As an example, tracking data may include the positions (e.g., x=(x, y)) of each entity (or player) at each time step on a playing surface. Tracking data may be generated and/or stored in a format different than the format of a game file or broadcast transmission. For example, a broadcast transmission may include video files, whereas tracking data may be generated or stored as digital representations of agents and/or objects in a format different than the format of the broadcast transmission (e.g., different than a video file format). In some embodiments, to represent the tracking data in a well-defined structure that avoids issues presented in conventional approaches, a pre-processing agent may construct a graphical representation of the tracking data. For example, prea-processing agent may construct a graph G(V,E,U) that may be defined by nodes V, edges E, and global features U. In some embodiments, each node in a graph may represent the player and ball tracking data. In some embodiments, each edge may include information about various relationships between nodes. In some embodiments, edges eij may be directed edges and connect a sending node vi to a receiving node vj.

In some embodiments, a game file may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing tracking data (e.g., from the tracking system), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a penalty event, a possession based event, play type event, etc.).

Event data (e.g., plurality of real-time event data, non-live event data, and/or plurality of historical event data at steps 705 and 710 of FIG. 7) may be automatically identified using a machine learning trained to receive, as an input, a game file or a subset thereof and output game information and/or context information based on the input. The machine learning model may be trained using supervised, semi-supervised, or unsupervised learning. The machine learning model may be trained by analyzing training data using one or more machine learning algorithms, as disclosed herein. The training data may include game files or simulated game files from historical games, simulated games, and/or the like and may include tagged and/or untagged data.

According to embodiments disclosed herein, event data may be generated based on tracking data and/or content feeds (e.g., in-venue video feeds, broadcast feeds, etc.). For example, tracking data may be generated by providing a content feed to one or more machine learning models. The one or more machine learning models may identify players and/or objects in the content feed and convert them to digital representations. The digital representations of the players and/or objects and their respective positions may be tracked to identify tracking data such as movement data (e.g., changes in the positions), changes in movement, trends, etc. Such information may be used by a prediction module to make predictions. The tracking data may be analyzed by the machine learning models to determine correlations between the tracking data and event types (e.g., goal scored, pass made, play types, etc.). For example, tracking data may be used to determine when a digital representation of an object (e.g., a ball) crosses a scoring object (e.g., a goal post). Based on such determination, an event type of a goal scored may be identified. Further, the digital representation of the player(s) that contacted the object (e.g., ball) prior to the goal scored event may be identified as the player(s) that contributed to or otherwise caused the event (e.g., goal). Accordingly, content feeds may be used to generate tracking data which may further be used to determine event data corresponding to certain sports events.

To identify events within the generated tracking data, the tracking data system may merge or align play-by-play data with the raw generated tracking data (which may include the game and time fields). Tracking data system may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, the tracking data system may be configured to perform various operations on the aligned tracking system. For example, the tracking data system may use the play-by-play data to refine the player and ball positions and precise frame of the end of possession events (e.g., shot/rebound location). In some embodiments, the tracking data system may further be configured to detect events, automatically, from the tracking data. In some embodiments, the tracking data system may further be configured to enhance the events with contextual information.

For automatic event detection, the tracking data system may include a neural network system trained to detect/refine various events in a sequential manner. For example, the tracking data system may include an actor-action attention neural network system to detect/refine one or more of: shots, scores, points, rebounds, passes, dribbles, penalties, fouls, and/or possessions. Tracking data system may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, specialist event detectors may use a neural network approach or another machine learning classifier (e.g., random decision forest, SVM, logistic regression etc.).

Accordingly, at step 705 of FIG. 7, the plurality of real-time event data may be received based on real-time tracking data associated with a game identifier corresponding to a sporting event. The real-time tracking data may be generated based on in-venue or broadcast feeds as discussed herein. The real-time event data may be automatically generated based on the real-time tracking data, as discussed herein. The real-time event data may be tagged with the real-time athlete elements (e.g., using computer vision techniques), as discussed herein. Similarly, at step 710, the plurality of historical event data may be received based on historical tracking data associated with one or more historical sporting events. The historical tracking data may be generated based on in-venue or broadcast feeds as discussed herein. The historical event data may be automatically generated based on the historical tracking data, as discussed herein. The historical event data may be tagged with the historical athlete elements (e.g., using computer vision techniques), as discussed herein.

At step 715, the plurality of real-time athlete elements and the plurality of historical athlete elements are provided to an AI model trained to identify associations between the plurality of real-time athlete elements and the plurality of historical athlete elements and to generate an output including one or more interactive elements based on the identified associations.

A generative AI model may receive the real-time event data, historical event data, and user input, as an input. The generative AI model may be iteratively trained based training data such as the event data received at or generated by event data module 104. Based on the training data, which may be updated in real time, the generative machine learning model may output a natural language output. The natural language output may be generated by, first, generating numerical values in response to the input and, second, converting the numerical values into the natural language output. Accordingly, the natural language model may be trained on sporting event data such that its output is specific to the sporting even data. In various embodiments, as described herein, user input may be parsed to identify target elements (e.g., by correlating the user input with real-time event data). The target elements may then be confirmed and/or validated using historical athletic elements to provide numerical values which may then be converted into natural language output. Therefore, a large language machine-learning model (LLM) may process the user input. The computer vision machine-learning model may then identify and output an object identifier that correlates with the user input. The output object identifier may then be provided to the LLM which may then generate the natural language output.

Generally, an artificial intelligence or machine-learning model disclosed herein includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the AI model may be configured to cause the AI model to learn associations between natural language data and real-time and historical event data, such that the trained AI model is configured to generate an output in response to receiving input.

In various embodiments, the variables of an AI model may be interrelated in any suitable arrangement in order to generate the output. For example, in some embodiments, the AI model may include natural language processing architecture that is configured to identify, isolate, and/or extract language features in input textual data. For example, the machine-learning model may include one or more convolutional neural network (“CNN”) configured to identify features in the text, and may include further architecture, e.g., a connected layer, neural network, etc., configured to determine a relationship between the identified features in order to determine and generate a natural language response that addresses the input, interaction, or the like.

In some embodiments, the machine-learning or artificial intelligence model may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account. A Seq2Seq model may be configured to, for example, receive text as input, and generate an output in real-time. In some embodiments, the machine-learning model may include a transformer model and/or graph neural network (GNN) model. Such models may be configured to generate an output from input data.

At step 720, the interactive user interface including the one or more interactive elements is generated. In examples, the interactive user interface may be generated in real time as the plurality of real-time event data is received. Additionally, the interactive user interface may be generated in response to one or more user interactions with the interactive user interface. At step 725, the interactive user interface is transmitted to a user device. In various embodiments, a user input associated with the plurality of real-time event data may be received via the interactive user interface. The user input may include one or more of a textual input, haptic input, and the like. The user input may be provided to the generative AI model trained to generate a sequence of outputs based on the user input, and the interactive user interface may include the sequence of outputs and the one or more interactive elements.

According to embodiments of the disclosed subject matter (e.g., as described with respect to FIGS. 6-7), steps may be performed in real-time, or based on real-time updates to data. For example, while a movie or prerecorded broadcast program may provide static or historical data, a real-time broadcast may provide dynamic, changing, real-time data associated with a sporting event. Therefore, aspects of the disclosed subject matter may process the real-time data in real time (e.g., within approximately 30 seconds, 1 minute, 5 minutes, or the like, of the real-time event occurring within the broadcast). Therefore, aspects of the disclosed subject matter provide real-time analysis and output.

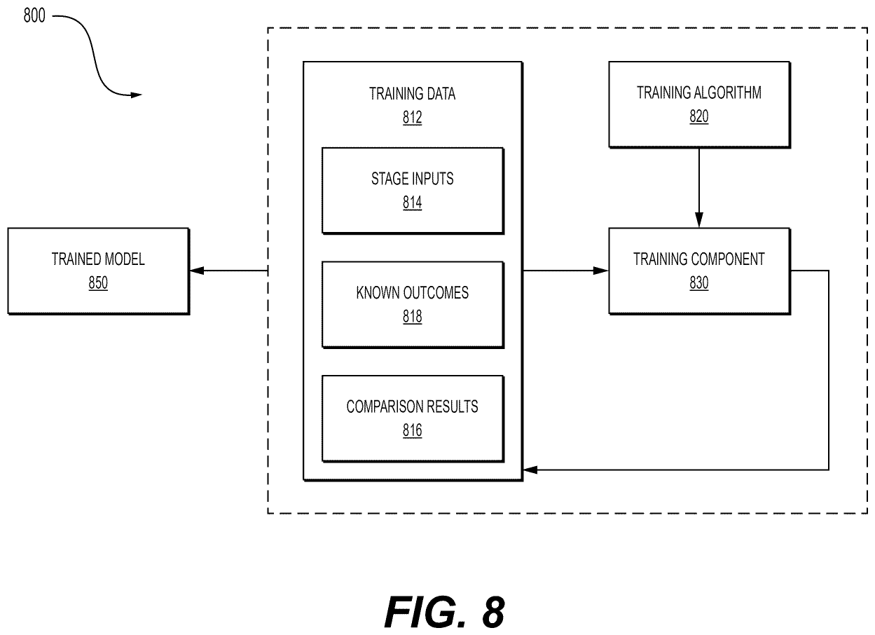

FIG. 8 depicts a flow diagram for training a machine-learning and/or AI model. As shown in flow diagram 800 of FIG. 8, training data 812 may include one or more of stage inputs 814 and known outcomes 818 related to a machine-learning model to be trained. The stage inputs 814 may be from any applicable source including a component or set shown in the figures provided herein. The known outcomes 818 may be included for machine-learning models generated based on supervised or semi-supervised training. An unsupervised machine-learning model might not be trained using known outcomes 818. Known outcomes 818 may include known or desired outputs for future inputs similar to or in the same category as stage inputs 814 that do not have corresponding known outputs.

The training data 812 and a training algorithm 820 may be provided to a training component 830 that may apply the training data 812 to the training algorithm 820 to generate a trained machine-learning model 850. According to an implementation, the training component 830 may be provided comparison results 816 that compare a previous output of the corresponding machine-learning model to apply the previous result to re-train the machine-learning model. The comparison results 816 may be used by the training component 830 to update the corresponding machine-learning model. The training algorithm 820 may utilize machine-learning networks and/or models including, but not limited to a deep learning network such as Graph Neural Networks (GNN), Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 800 may be a trained machine-learning model 850.

A machine-learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine-learning model (e.g., a trained model) based on the training. Once trained, the machine-learning model may output machine-learning model outputs in accordance with the subject matter disclosed herein. According to an implementation, one or more machine-learning models disclosed herein may continuously update based on feedback associated with use or implementation of the machine-learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

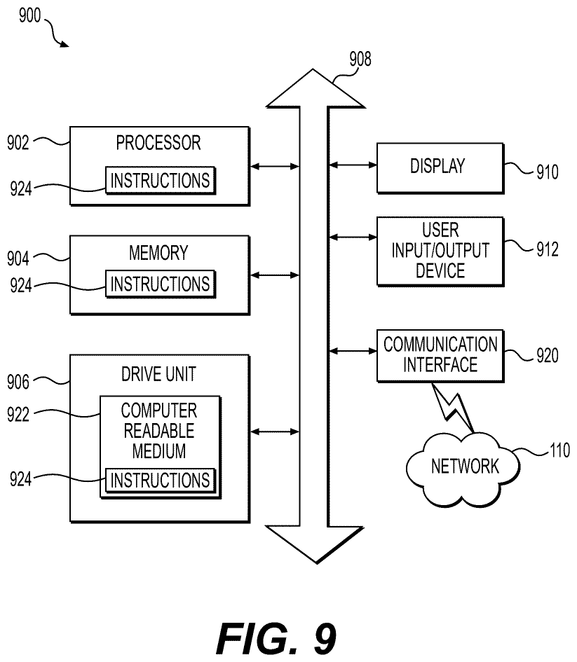

FIG. 9 is a simplified functional block diagram of a computer 900 that may be configured as a device for executing the methods disclosed here, according to exemplary aspects of the present disclosure. For example, the computer 900 may be configured as a system according to exemplary aspects of this disclosure. In various aspects, any of the systems herein may be a computer 900 including, for example, a data communication interface 920 for packet data communication. The computer 900 also may include a central processing unit (“CPU”) 902, in the form of one or more processors, for executing program instructions. The computer 900 may include an internal communication bus 908, and a storage unit 906 (such as ROM, HDD, SDD, etc.) that may store data on a computer readable medium 922, although the computer 900 may receive programming and data via network communications.

The computer 900 may also have a memory 904 (such as RAM) storing instructions 924 for executing techniques presented herein, for example the systems and methods described with respect to FIGS. 1-8, although the instructions 924 may be stored temporarily or permanently within other modules of computer 900 (e.g., processor 902 and/or computer readable medium 922). The computer 900 also may include input and output ports 912 and/or a display 910 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for generating an interactive user interface using artificial intelligence models of a computing system, the method comprising:
receiving, by one or more processors, one or more streams of event data comprising a plurality of visual elements;
providing, by the one or more processors, the plurality of visual elements to a computer vision artificial intelligence model trained to classify the plurality of visual elements and output one or more object identifiers and a confidence score associated with each of the one or more object identifiers;
receiving, by the one or more processors, user input from the interactive user interface displayed on a user device, the user input including a user query associated with a first object identifier of the one or more object identifiers; and
updating, by the one or more processors, the interactive user interface with one or more interactive user elements associated with the first object identifier.

2. The computer-implemented method of claim 1, wherein the plurality of visual elements are real-time visual elements or non-live visual elements and are associated with a game identifier.

3. The computer-implemented method of claim 1, further comprising:
receiving, by the one or more processors, a plurality of metadata associated with a plurality of entities; and
providing, by the one or more processors, the plurality of metadata to the computer vision artificial intelligence model trained to identify associations between the plurality of metadata and the one or more object identifiers and output one or more entities of the plurality of entities, the one or more entities associated with the first object identifier.

4. The computer-implemented method of claim 3, wherein the one or more interactive user elements are associated with the one or more entities.

5. The computer-implemented method of claim 3, wherein the one or more entities are each associated with a weighted score.

6. The computer-implemented method of claim 3, further comprising:
receiving, by the one or more processors and from the interactive user interface, a second user query associated with the first object identifier;
providing, by the one or more processors, the second user query, the first object identifier, and the plurality of metadata to a language artificial intelligence model trained to identify patterns between the second user query, the first object identifier, and the plurality of metadata and output one or more recommendations; and
updating, by the one or more processors, the interactive user interface with one or more second interactive user elements based on the one or more recommendations.

7. The computer-implemented method of claim 1, further comprising:
generating, by the one or more processors, a data structure including an object identifier of the one or more object identifiers and the confidence score associated with the object identifier; and
storing, by the one or more processors, the data structure in a database associated with the computing system.

8. A computing system for generating an interactive user interface using artificial intelligence models, the computing system comprising:
a memory storing instructions; and
one or more processors operatively connected to the memory and configured to execute the instructions to perform operations including:
receiving, by the one or more processors, one or more streams of event data comprising a plurality of visual elements;
providing, by the one or more processors, the plurality of visual elements to a computer vision artificial intelligence model trained to classify the plurality of visual elements and output one or more object identifiers and a confidence score associated with each of the one or more object identifiers;
receiving, by the one or more processors, user input from the interactive user interface displayed on a user device, the user input including a user query associated with a first object identifier of the one or more object identifiers; and
updating, by the one or more processors, the interactive user interface with one or more interactive user elements associated with the first object identifier.

9. The computing system of claim 8, wherein the plurality of visual elements are real-time visual elements or non-live visual elements and are associated with a game identifier.

10. The computing system of claim 8, the operations further comprising:
receiving, by the one or more processors, a plurality of metadata associated with a plurality of entities; and
providing, by the one or more processors, the plurality of metadata to the computer vision artificial intelligence model trained to identify associations between the plurality of metadata and the one or more object identifiers and output one or more entities of the plurality of entities, the one or more entities associated with the first object identifier.

11. The computing system of claim 10, wherein the one or more interactive user elements are associated with the one or more entities.

12. The computing system of claim 10, wherein the one or more entities are each associated with a weighted score.

13. The computing system of claim 10, the operations further comprising:
receiving, by the one or more processors and from the interactive user interface, a second user query associated with the first object identifier;
providing, by the one or more processors, the second user query, the first object identifier, and the plurality of metadata to a language artificial intelligence model trained to identify patterns between the second user query, the first object identifier, and the plurality of metadata and output one or more recommendations; and
updating, by the one or more processors, the interactive user interface with one or more second interactive user elements based on the one or more recommendations.

14. The computing system of claim 8, the operations further comprising:
generating, by the one or more processors, a data structure including an object identifier of the one or more object identifiers and the confidence score associated with the object identifier; and
storing, by the one or more processors, the data structure in a database associated with the computing system.

15. A non-transitory computer-readable medium storing instructions that, when executed by one or more processors, perform operations including:
receiving, by the one or more processors, one or more streams of event data comprising a plurality of visual elements;
providing, by the one or more processors, the plurality of visual elements to a computer vision artificial intelligence model trained to classify the plurality of visual elements and output one or more object identifiers and a confidence score associated with each of the one or more object identifiers;
receiving, by the one or more processors, user input from an interactive user interface displayed on a user device, the user input including a user query associated with a first object identifier of the one or more object identifiers; and
updating, by the one or more processors, the interactive user interface with one or more interactive user elements associated with the first object identifier.

16. The non-transitory computer-readable medium of claim 15, wherein the plurality of visual elements are real-time visual elements or non-live visual elements and are associated with a game identifier.

17. The non-transitory computer-readable medium of claim 15, the operations further comprising:
receiving, by the one or more processors, a plurality of metadata associated with a plurality of entities; and
providing, by the one or more processors, the plurality of metadata to the computer vision artificial intelligence model trained to identify associations between the plurality of metadata and the one or more object identifiers and output one or more entities of the plurality of entities, the one or more entities associated with the first object identifier.

18. The non-transitory computer-readable medium of claim 17, wherein the one or more interactive user elements are associated with the one or more entities.

19. The non-transitory computer-readable medium of claim 17, wherein the one or more entities are each associated with a weighted score.

20. The non-transitory computer-readable medium of claim 17, the operations further comprising:
receiving, by the one or more processors and from the interactive user interface, a second user query associated with the first object identifier;
providing, by the one or more processors, the second user query, the first object identifier, and the plurality of metadata to a language artificial intelligence model trained to identify patterns between the second user query, the first object identifier, and the plurality of metadata and output one or more recommendations; and
updating, by the one or more processors, the interactive user interface with one or more second interactive user elements based on the one or more recommendations.
